(19) United States
(12) Patent Application Publication
(10) Pub. No.: US 2025/0314743 A1
(43) Pub. Date: Oct. 9, 2025

(54) GESTURE SENSING DEVICE AND GESTURE SENSING METHOD

(71) Applicant: Samsung Display Co., Ltd., Yongin-Si (KR)

(72) Inventors: Masahiko TAKIGUCHI, Yokohama (JP); Kazuhiro MATSUMOTO, Yokohama (JP); Satoshi UCHINO, Yokohama (JP)

(21) Appl. No.: 18/979,597

(22) Filed: Dec. 13, 2024

(30) Foreign Application Priority Data
Apr. 4, 2024 (KR) 10-2024-0045965

(51) Int. Cl. G01S 7/41

(52) U.S. Cl. CPC G01S 7/415; G01S 7/417

(57) ABSTRACT

A gesture sensing device is provided, which includes a preprocessing unit that receives radar data from a sensor, generates a first range-Doppler map including a distance to an object and information about a relative speed based on the radar data and a second range-Doppler map, a motion sensing unit that receives the first range-Doppler map and generates a motion information including a motion start and a motion end based on a signal strength calculated based on the first range-Doppler map, and a gesture sensing unit that receives the second range-Doppler amp and the motion information, and generates a gesture probability by classifying gesture features of the object based on the second range-Doppler map. The second range-Doppler map may be generated in the preprocessing unit using the first range-Doppler map and the motion information.

### CROSS-REFERENCE TO RELATED APPLICATIONS

This application claims priority under 35 U.S.C. § 119 to Korean Patent Application No. 10-2024-0045965 filed on Apr. 4, 2024, in the Korean Intellectual Property Office, the disclosures of which are incorporated by reference herein in their entireties.

### BACKGROUND

Embodiments of the present disclosure described herein relate to a gesture sensing device and a gesture sensing method with improved reliability.

Millimeter waves have a high-band frequency ranging from 30 GHz to 300 GHz. The millimeter waves have strong directivity and are not affected by weather, making them applicable in autonomous driving technologies, such as collision avoidance in automobiles.

In addition, since an antenna that transmits and receives the millimeter waves may be miniaturized, the millimeter waves may also be used in traffic monitoring and surveillance sensors.

### SUMMARY

Embodiments of the present disclosure provide a gesture sensing device and a gesture sensing method with improved reliability.

According to an embodiment of the present disclosure, a gesture sensing device includes a preprocessing unit that receives radar data from a sensor, and generates a first range-Doppler map including a distance to an object and information about a relative speed based on the radar data and a second range-Doppler map, a motion sensing unit that receives the first range-Doppler map and generates a motion information including a motion start and a motion end based on a signal strength calculated based on the first range-Doppler map, and a gesture sensing unit that receives the second range-Doppler map and the motion information, and generates a gesture probability by classifying gesture features of the object based on the second range-Doppler map. The second range-Doppler map may be generated in the preprocessing unit using the first range-Doppler map and the motion information.

The gesture sensing device may further include a memory unit that stores the first range-Doppler map of each of a plurality of frames, and the motion sensing unit may calculate a plurality of differential signal strengths, each of which may be calculated using signal strengths of two adjacent frames, and may calculate an average value of the plurality of differential signal strengths.

The motion sensing unit may determine the motion start based on the average value and a slope value obtained by differentiating the average value.

The motion sensing unit may calculate a normal signal strength by normalizing the average value during a period between a time of the motion start and a present time, and may determine the motion end based on a magnitude of the normal signal strength.

The preprocessing unit may include a range-Doppler map generating unit that generates the first range-Doppler map, a peak sensing unit that senses the distance based on a peak of the signal strength, a beamforming unit that calculates an angle to the object based on the first range-Doppler map, and a range-Doppler map conversion unit that generates the second range-Doppler map.

The preprocessing unit may further include a filter unit that receives the radar data, and the filter unit may include an infinite impulse response filter.

The range-Doppler map conversion unit may generate the second range-Doppler map by performing a parallel movement of the first range-Doppler map based on the distance in accordance with the motion start and the motion end.

The preprocessing unit may further include a motion log unit, and the motion log unit may receive the motion information, the distance and the angle, and may record and output the distance and the angle during a period between the motion start and the motion end.

The gesture sensing unit may include a convolution neural network (CNN) and a long short-term memory (LSTM).

A gesture sensing device may further include a postprocessing unit that receives the motion information, the distance, the angle and the gesture probability, and outputs a gesture of the object.

The postprocessing unit may include a normalization unit that normalizes the gesture probability and classifies the gesture probability above a predetermined value during a period between the motion start and the motion end, a counter unit that counts the gesture probability during the period between the motion start and the motion end to output a count value, and a gesture determination unit that outputs the gesture based on the distance and the angle, starting with the gesture probability having a highest count value after the motion end.

The radar data may be a signal received in a millimeter wave.

The preprocessing unit may perform a fast Fourier transform on the radar data to generate the first range-Doppler map.

According to an embodiment of the present disclosure, a gesture sensing method includes generating a first range-Doppler map including a distance to an object and information about a relative speed based on radar data, generating motion information including a motion start and a motion end based on a signal strength calculated based on the first range-Doppler map, generating a second range-Doppler map different from the first range-Doppler map based on the first range-Doppler map and the motion information, and generating a gesture probability by classifying gesture features of the object based on the second range-Doppler map.

The generating the motion information may include calculating a plurality of differential signal strengths, each of which may be calculated using signal strengths of two adjacent frames, calculating an average value of the plurality of differential signal strengths, determining the motion start based on the average value and a slope value obtained by differentiating the average value, calculating a normal signal strength by normalizing the average value during a period between a time of the motion start and a present time, and determining the motion end based on a magnitude of the normal signal strength.

The generating the second range-Doppler map may include performing a parallel movement of the first range-Doppler map based on the distance in accordance with the motion start and the motion end.

The generating the gesture probability may include outputting the gesture probability from the second range-Doppler map using a convolution neural network (CNN) and a long short-term memory (LSTM).

The gesture sensing method may further include receiving the motion information, the distance and the gesture probability, and outputting a gesture of the object.

The outputting the gesture may include normalizing the gesture probability and classifying the gesture probability above a predetermined value during a period between the motion start and the motion end, counting the gesture probability during the period between the motion start and the motion end and outputting a count value, and outputting a gesture signal including the gesture based on the distance, starting the gesture probability having a highest count value after the motion end. The radar data may be a signal received in a millimeter wave.

### BRIEF DESCRIPTION OF THE FIGURES

The above and other features of the present disclosure will become apparent with reference to the following descriptions taken in conjunction with the accompanying drawings.

FIG. 1 is a block diagram of a gesture sensing system, according to an embodiment of the present disclosure.

FIG. 2 is a flowchart illustrating a gesture sensing method, according to an embodiment of the present disclosure.

FIG. 3 is a block diagram illustrating a gesture sensing device, according to an embodiment of the present disclosure.

FIG. 4 is a block diagram illustrating a preprocessing unit, according to an embodiment of the present disclosure.

FIG. 5 is a diagram illustrating a range and Doppler, according to an embodiment of the present disclosure.

FIG. 6 is a diagram illustrating a first range-Doppler map, according to an embodiment of the present disclosure.

FIG. 7 is a flowchart illustrating an operation of a motion sensing unit, according to an embodiment of the present disclosure.

FIG. 8 is a graph illustrating output values from a motion sensing unit, according to an embodiment of the present disclosure.

FIG. 9 is a diagram illustrating an operation of a range-Doppler map conversion unit, according to an embodiment of the present disclosure.

FIG. 10 is a block diagram illustrating a gesture sensing unit, according to the present disclosure.

FIG. 11 is a diagram illustrating types of gestures, according to an embodiment of the present disclosure.

FIG. 12 is a block diagram illustrating a postprocessing unit, according to an embodiment of the present disclosure.

FIG. 13A is a graph illustrating a gesture probability, according to an embodiment of the present disclosure.

FIG. 13B is a graph illustrating a normal gesture probability, according to an embodiment of the present disclosure.

FIG. 13C is a graph illustrating gesture candidates, according to an embodiment of the present disclosure.

FIG. 13D is a graph illustrating count values and motion information, according to an embodiment of the present disclosure.

FIG. 13E is a graph illustrating a distance, an angle, and motion information, according to an embodiment of the present disclosure.

FIG. 14 is a diagram illustrating gestures depending on a distance and an angle, according to an embodiment of the present disclosure.

### DETAILED DESCRIPTION

In the specification, when one component (or area, layer, part, or the like) is referred to as being “on”, “connected to”, or “coupled to” another component, it should be understood that the former may be directly on, connected to, or coupled to the latter, and also may be indirectly on, connected to, or coupled to the latter via a third intervening component.

Like reference numerals refer to like components. Also, in drawings, the thickness, ratio, and dimension of components are exaggerated for effective description of the present disclosure. The term “or” means logical “or” so that, unless the context indicates otherwise, the expression “A, B, or C” means “A and B and C,” “A and B but not C,” “A and C but not B,” “B and C but not A,” “A but not B and not C,” “B but not A and not C,” and “C but not A and not B.”.

The terms “first”, “second”, etc. are used to describe various components, but the components are not limited by the terms. The terms are used only to differentiate one component from another component. For example, a first component may be named as a second component, and vice versa, without departing from the spirit or scope of the present disclosure. A singular form, unless otherwise stated, includes a plural form.

Also, the terms “under”, “beneath”, “on”, “above” are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, but do not preclude the presence or addition of one or more other features, numbers, steps, operations, elements, or components or a combination thereof.

Unless defined otherwise, all terms (including technical and scientific terms) used herein have the same meaning as commonly understood by one of ordinary skill in the art to which this disclosure belongs. In addition, it will be understood that terms, such as those defined in commonly used dictionaries, should be interpreted as having a meaning consistent with the meaning in the context of the related technology, and should not be interpreted as an idealized or excessively formal meaning unless explicitly defined in the present disclosure.

Hereinafter, embodiments of the present disclosure will be described with reference to accompanying drawings.

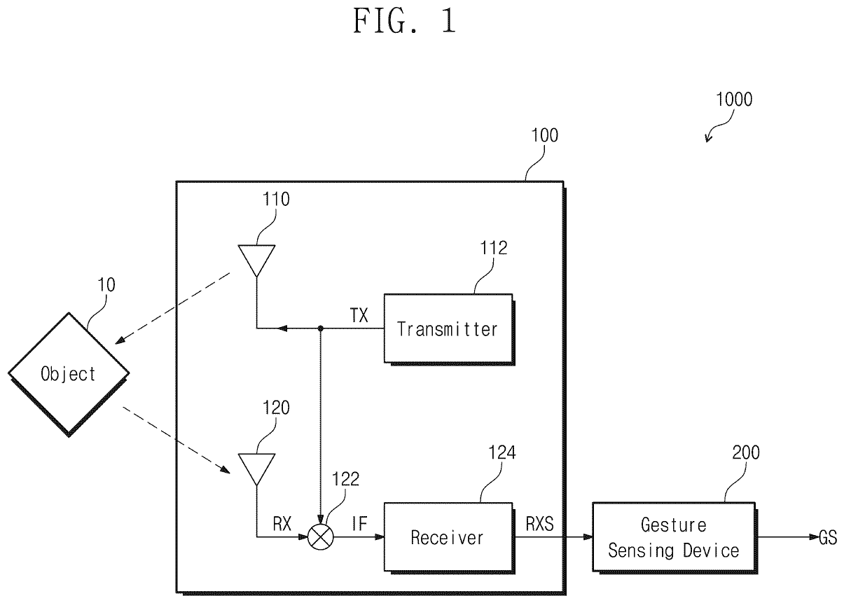

FIG. 1 is a block diagram of a gesture sensing system, according to an embodiment of the present disclosure.

Referring to FIG. 1, a gesture sensing system 1000 may include a sensor 100 and a gesture sensing device 200.

The sensor 100 may include a transmitting antenna 110, a transmitter 112, a receiving antenna 120, a mixer 122, and a receiver 124.

The transmitter 112 may output a transmission signal TX of a millimeter wave to the transmitting antenna 110. The transmission signal TX of the millimeter wave output from the transmitting antenna 110 may be reflected by an object 10 and may be transferred to the receiving antenna 120. The mixer 122 may combine the transmission signal TX from the transmitter 112 and a reception signal RX received from the receiving antenna 120 to output an intermediate frequency signal IF.

The intermediate frequency signal IF may include a phase difference between the transmission signal TX and the reception signal RX caused by a physical distance difference between the transmitting antenna 110 and the receiving antenna 120.

The receiver 124 may perform filtering and analog-to-digital conversion on the intermediate frequency signal IF output from the mixer 122 and may output radar data RXS to the gesture sensing device 200. For example, the intermediate frequency signal IF may be an analog signal, and the radar data RXS may be a digital signal.

The gesture sensing device 200 may receive the radar data RXS. The gesture sensing device 200 may determine a gesture of the object 10 based on the radar data RXS and may output a gesture signal GS including the gesture.

The gesture sensing system 1000 may sense the object 10 using a phase difference between the transmission signal TX and the reception signal RX caused by the physical distance between the gesture sensing system 1000 and the object 10.

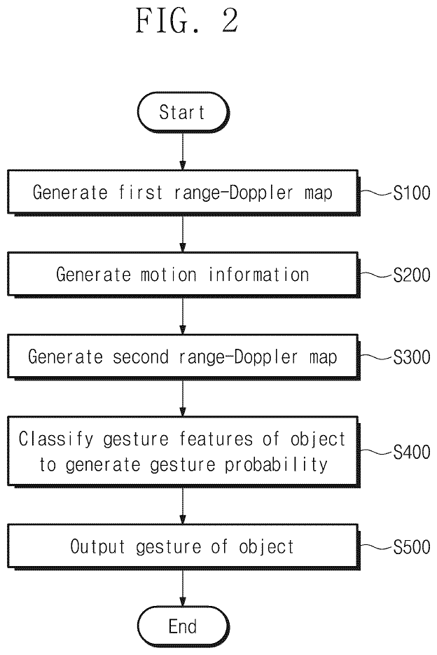

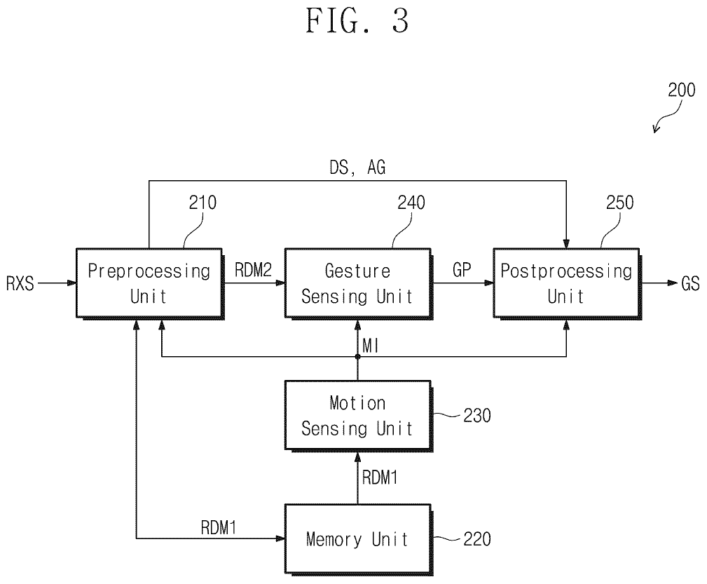

FIG. 2 is a flowchart illustrating a gesture sensing method, according to an embodiment of the present disclosure, and FIG. 3 is a block diagram illustrating a gesture sensing device, according to an embodiment of the present disclosure.

Referring to FIGS. 1 to 3, a gesture sensing method according to an embodiment of the present disclosure may include generating a first range-Doppler map RDM1 including a distance DS to the object 10 and information about a relative speed based on the radar data RXS (S100), generating motion information MI based on a signal strength calculated based on the first range-Doppler map RDM1 (S200), generating a second range-Doppler map RDM2 based on the first range-Doppler map RDM1 and the motion information MI (S300), generating a gesture probability GP by classifying gesture features of the object 10 based on the second range-Doppler map RDM2 (S400), and receiving the motion information MI, the distance DS, an angle AG, and the gesture probability GP, and outputting a gesture signal GS including a gesture of the object 10 (S500). The gesture sensing method according to an embodiment will be described later.

The gesture sensing device 200 may include a preprocessing unit 210, a memory unit 220, a motion sensing unit 230, a gesture sensing unit 240, and a postprocessing unit 250.

The preprocessing unit 210 may receive the radar data RXS from the sensor 100. The preprocessing unit 210 may generate the first range-Doppler map RDM1 based on the radar data RXS (S100). The preprocessing unit 210 may transmit the first range-Doppler map RDM1 to the memory unit 220. The preprocessing unit 210 may generate the second-Doppler map RDM2 and output to the gesture sensing unit 240.

The preprocessing unit 210 may generate the distance DS and the angle AG to the object 10 based on the radar data RXS. The preprocessing unit 210 may transmit the distance DS and the angle AG to the postprocessing unit 250.

The memory unit 220 may store the first range-Doppler map RDM1 received from the preprocessing unit 210. For example, the memory unit 220 may store a plurality of first range-Doppler maps RDM1 generated during each frame in which the gesture sensing device 200 operates.

The motion sensing unit 230 may receive the first range-Doppler map RDM1 of a current frame and the first range-Doppler map RDM1 of a previous frame from the memory unit 220. The motion sensing unit 230 may generate the motion information MI including a motion start and a motion end (S200) and may transmit the generated motion information MI to the preprocessing unit 210, the gesture sensing unit 240, and the postprocessing unit 250, respectively.

The gesture sensing unit 240 may receive the second range-Doppler map RDM2 from the preprocessing unit 210 and may receive the motion information MI from the motion sensing unit 230. The gesture sensing unit 240 may classify gesture features of the object 10 based on the second range-Doppler map RDM2 and may generate the gesture probability GP (S400). The gesture sensing unit 240 may transmit the gesture probability GP to the postprocessing unit 250.

The postprocessing unit 250 may receive the distance DS and the angle AG from the preprocessing unit 210, may receive the motion information MI from the motion sensing unit 230, and may receive the gesture probability GP from the gesture sensing unit 240. The postprocessing unit 250 may output the gesture signal GS including a gesture of the object 10 (S500).

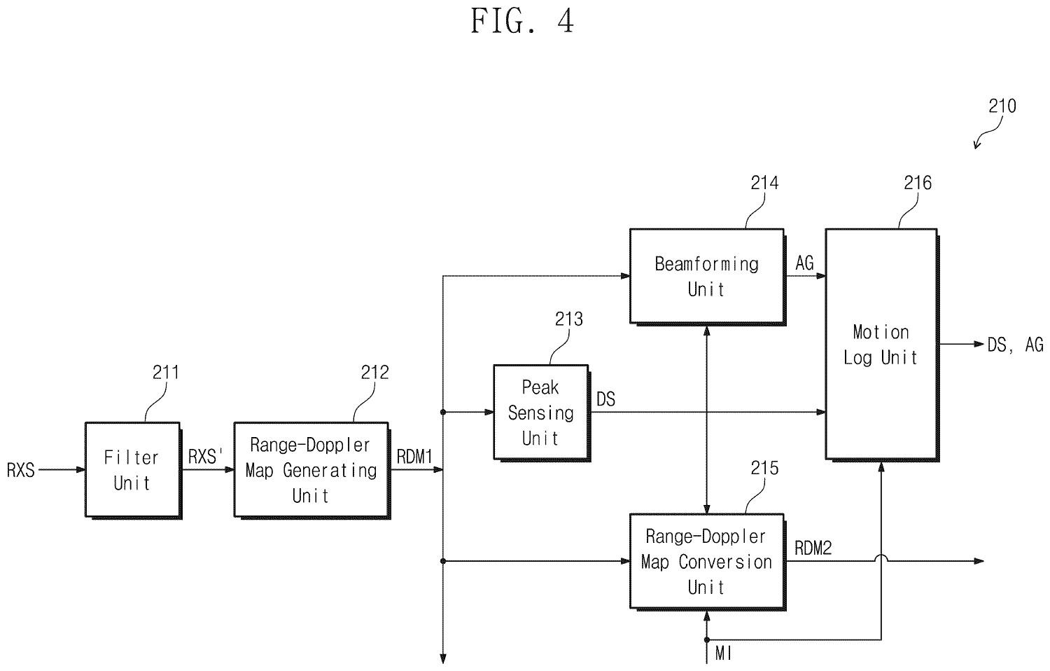

FIG. 4 is a block diagram illustrating a preprocessing unit, according to an embodiment of the present disclosure.

Referring to FIG. 4, the preprocessing unit 210 may output meaningful information from the radar data RXS through the first range-Doppler map RDM1 and the second range-Doppler map RDM2.

The preprocessing unit 210 may include a filter unit 211, a range-Doppler map generating unit 212, a peak sensing unit 213, a beamforming unit 214, a range-Doppler map conversion unit 215, and a motion log unit 216.

The filter unit 211 may receive the radar data RXS. The filter unit 211 may process the radar data RXS.

The filter unit 211 may include an infinite impulse response filter and a chirp direct current converter. The infinite impulse response filter may remove fixed objects from the radar data RXS. The chirp DC converter may remove noise by applying a DC offset to each chirp of the radar data RXS. The filter unit 211 may output converted radar data RXS' in which the radar data RXS is processed.

The range-Doppler map generating unit 212 may generate the first range-Doppler map RDM1.

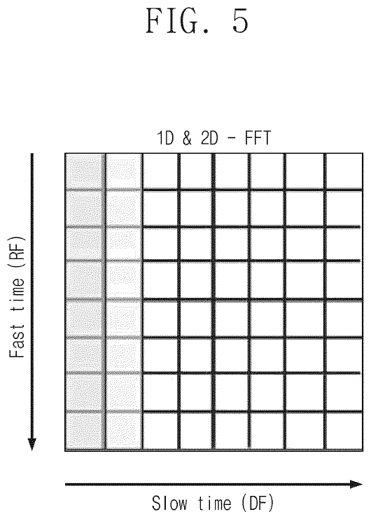

The peak sensing unit 213 may sense the distance DS based on the peak of the signal strength calculated from the first range-Doppler map RDM1. The distance DS may have a value substantially equal to a range RF (refer to FIG. 5).

The beamforming unit 214 may calculate the angle AG to the object 10 (refer to FIG. 1) based on the first range-Doppler map RDM1. The beamforming unit 214 may perform a digital beam forming (DBF). The beamforming unit 214 may calculate the angle AG based on azimuth information calculated from the digital beam forming (DBF). The beamforming unit 214 may calculate only the angle AG to the object 10, and the distance DS from the object 10 (refer to FIG. 1) may be calculated through the peak sensing unit 213, thereby reducing the computational load of the preprocessing unit 210.

The range-Doppler map conversion unit 215 may generate the second range-Doppler map RDM2.

The motion log unit 216 may receive the motion information MI, the distance DS, and the angle AG. The motion log unit 216 may record and may output the changes in each of distance DS and angle AG during a period between the motion start and the motion end.

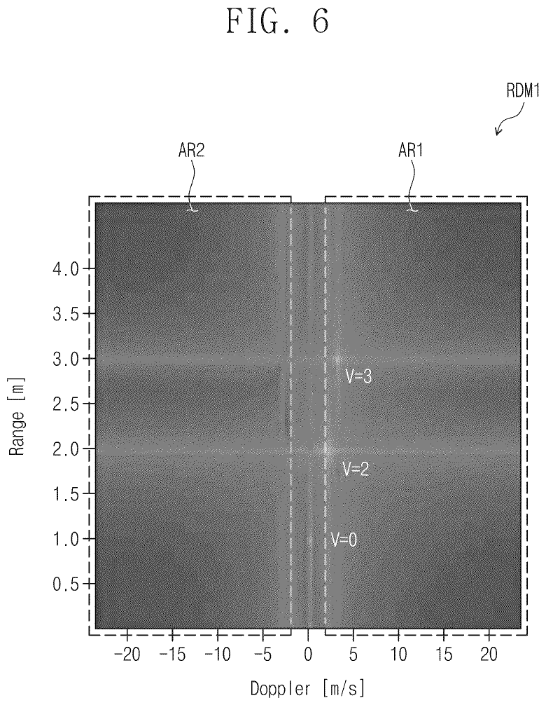

FIG. 5 is a diagram illustrating a range and Doppler, according to an embodiment of the present disclosure, and FIG. 6 is a diagram illustrating a first range-Doppler map, according to an embodiment of the present disclosure.

Referring to FIGS. 4 to 6, the range-Doppler map generating unit 212 may receive the converted radar data RXS'.

The range-Doppler map generating unit 212 may perform a fast Fourier transform by sampling the converted radar data RXS'. The range-Doppler map generating unit 212 may include a range-fast Fourier transform (FFT) converter and a Doppler-FFT converter.

The range-FFT converter may perform FFT on the converted radar data RXS′ in the time direction to obtain range information with respect to “fast time”. The range-FFT converter may output the range RF. The range RF output from the range-FFT converter may be the distance between the gesture sensing system 1000 (refer to FIG. 1) and the object 10 (refer to FIG. 1). In an embodiment, the range-FFT converter may be a one-dimensional (1D) FFT.

The Doppler-FFT converter may perform a Doppler-FFT on the range RF and may perform the FFT in the time direction to output a Doppler DF. The Doppler-FFT converter may be called “slow time” since it performs the Doppler-FFT only once per frame. The Doppler DF output from the Doppler-FFT converter may be the relative speed with respect to the object 10 (refer to FIG. 1). In an embodiment, the Doppler-FFT converter may be a two-dimensional (2D) FFT.

The first range-Doppler map RDM1 illustrated in FIG. 6 may be generated by the range-FFT converter and the Doppler-FFT converter. FIG. 6 illustrates the ranges RF as an example when Doppler ‘V’ is 0 m/s, 2 m/s, and 3 m/s.

In the first range-Doppler map RDM1, a vertical axis may represent the range RF, which is the distance between the sensor 10 and the object 10 (refer to FIG. 1).

In the first range-Doppler map RDM1, a horizontal axis may represent the speed at which the object 10 (refer to FIG. 1) approaches or moves away from the sensor 100 (refer to FIG. 1). Since a section at ‘0’ and adjacent to ‘0’ on the horizontal axis represent a period when an object is not moved, information may be processed by paying attention to a first area AR1 and a second area AR2 excluding the period when the object is not moved.

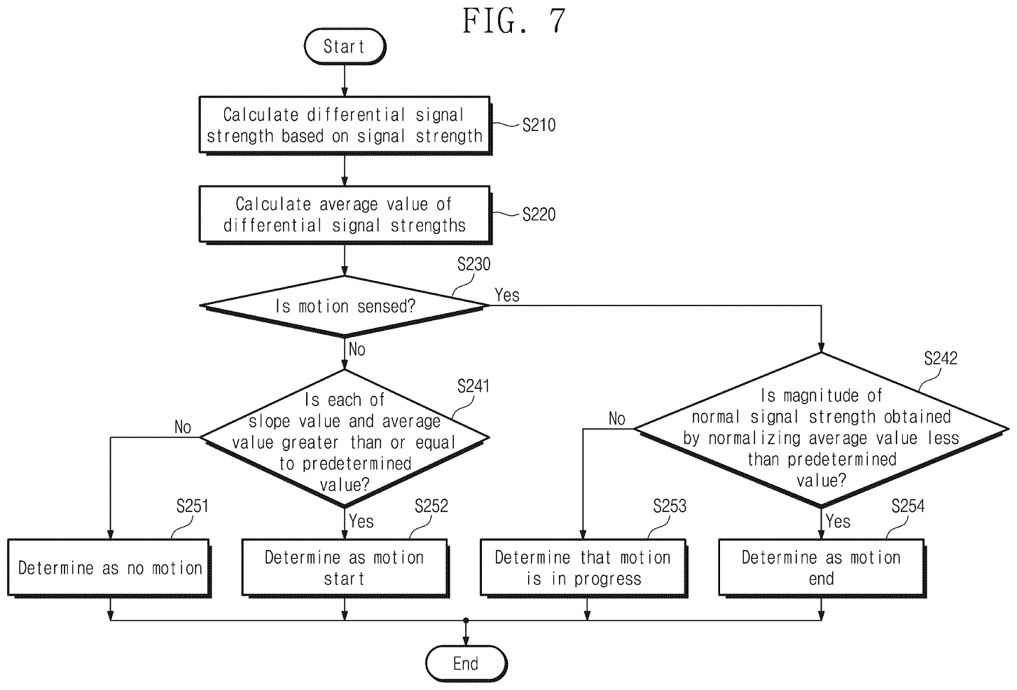

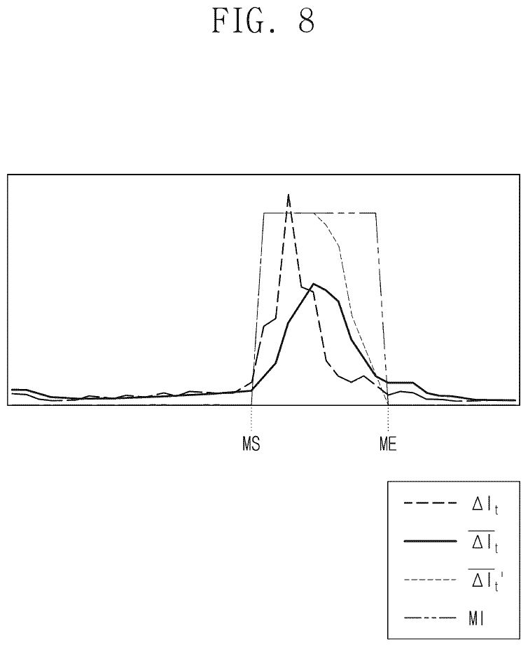

FIG. 7 is a flowchart illustrating an operation of a motion sensing unit, according to an embodiment of the present disclosure, and FIG. 8 is a graph illustrating output values from a motion sensing unit, according to an embodiment of the present disclosure.

Referring to FIGS. 4, 7, and 8, the motion sensing unit 230 may receive the first range-Doppler map RDM1 of the previous frame from the memory unit 220. The motion sensing unit 230 may obtain the motion information MI having improved clarity by removing a normal noise through the differentiation between the current first range-Doppler map RDM1 and the past first range-Doppler map RDM1.

The motion information MI may include information about a motion start MS and a motion end ME.

The motion sensing unit 230 may calculate a difference between a signal strength Iₜ of the first range-Doppler map RDM1 at a current time ‘t’ and a signal strength Iₜ₋₁ of the first range-Doppler map RDM1 at a past time t-1.

The motion sensing unit 230 may calculate a differential signal strength ΔIₜ of two adjacent frames based on Equation 1 below (S210).

$$Δ {I}_{t} = \sum \vert {I}_{t} - {I}_{t - 1} \vert \qquad [ Equation 1 ]$$

In Equation 1, Iₜ represents the signal strength Iₜ of the first range-Doppler map RDM1 at the current time ‘t’, and Iₜ₋₁ represents the signal strength Iₜ₋₁ of the first range Doppler map RDM1 at the past time t-1.

The differential signal strength Alt may be calculated from each of a plurality of frames.

The motion sensing unit 230 may calculate the average value ΔIₜ of the plurality of differential signal strengths ΔIₜ based on Equation 2 (S220).

$$\overline{Δ {I}_{t}} = {\sum }_{x = t - 4}^{t} Δ {I}_{x} / 5 \qquad [ Equation 2 ]$$

As shown in Equation 2 above, the present disclosure illustrates an example in which the average value of the differential signal strength is calculated over the past 5 frames. However, constants ‘5’ and ‘4’ in Equation 2 according to an embodiment of the present disclosure are not limited thereto. For example, the constants may vary depending on the number of frames used to calculate the average value by the motion sensing unit 230.

In an embodiment, the motion sensing unit 230 may sense a motion (S230). The motion sensing unit 230 may proceed with a detection of the motion start MS when the motion is not sensed, and may proceed with a detection of the motion end ME when the motion is sensed.

When the detection of the motion start MS is performed, the motion sensing unit 230 may calculate the slope value ‘slope’ by differentiating the average value Δ̅I̅ₜ̅. In detail, the motion sensing unit 230 may calculate the slope value ‘slope’ based on Equation 3 below.

$$slope = ( \overline{Δ {I}_{t}} - \overline{Δ {I}_{t - 1}} ) / \overline{Δ {I}_{t - 1}} \qquad [ Equation 3 ]$$

In Equation 3 above, ‘slope’ may refer to a slope value. The slope may represent a rate of a change of the average value Δ̅I̅ₜ̅.

The motion sensing unit 230 may determine the motion start MS based on the slope value ‘slope’ and the average value Δ̅I̅ₜ̅.

The motion sensing unit 230 may determine whether each of the slope value ‘slope’ and the average value Δ̅I̅ₜ̅ is equal to or greater than a predetermined value (S241).

When at least one of the slope value ‘slope’ and the average value Δ̅I̅ₜ̅ is less than the predetermined value, the motion sensing unit 230 may determine that there is no motion (S251).

The motion sensing unit 230 may determine that there is the motion start MS when the slope value ‘slope’ and the average value Δ̅I̅ₜ̅ are equal to or greater than the predetermined value (S252). For example, the motion sensing unit 230 may determine that there is the motion start MS when the slope value ‘slope’ is equal to or greater than 20% and the average value Δ̅I̅ₜ̅ is equal to or greater than 0.1.

To detect the motion end ME, the motion sensing unit 230 may normalize the average value Δ̅I̅ₜ̅ during the period from the motion start MS to the present based on Equations 4 and 5 below and obtain the normal signal strength Δ̅I̅ₜ̅′.

$$\{ \begin{matrix}max = max ( \overline{Δ {I}_{t}} ) \\ min = min ( \overline{Δ {I}_{t}} )\end{matrix} t = start ∼ now \qquad [ Equation 4 ]$$

$${\overline{Δ {I}_{t}}}^{′} = ( \overline{Δ {I}_{t}} - min ) / ( max - min ) \qquad [ Equation 5 ]$$

In Equation 4, ‘max’ and ‘min’ may refer to the maximum value ‘max’ and the minimum value ‘min’ of the average value Δ̅I̅ₜ̅ from the motion start MS to the present, respectively. Equation 5 may be an equation for calculating a normal signal strength Δ̅I̅ₜ̅′ obtained by normalizing the average value Δ̅I̅ₜ̅ based on the maximum value ‘max’ and the minimum value ‘min’.

The motion sensing unit 230 may determine the motion end ME based on a magnitude of the normal signal strength Δ̅I̅ₜ̅′.

The motion sensing unit 230 may determine whether the magnitude of the normal signal strength Δ̅I̅ₜ̅′ is less than a predetermined value (S242).

The motion sensing unit 230 may determine that a motion is in progress when the magnitude of the normal signal strength Δ̅I̅ₜ̅′ exceeds the predetermined value (S253).

The motion sensing unit 230 may detect the motion end ME when the normal signal strength Δ̅I̅ₜ̅′ becomes less than the predetermined value (S254). For example, the predetermined value may be 10%.

The motion sensing unit 230 may uniformly determine whether the object 10 (refer to FIG. 1) is moving regardless of the signal strength Iₜ, which is related to the amount of movement of and the distance to the object 10, through the normal signal strength Δ̅I̅ₜ̅′.

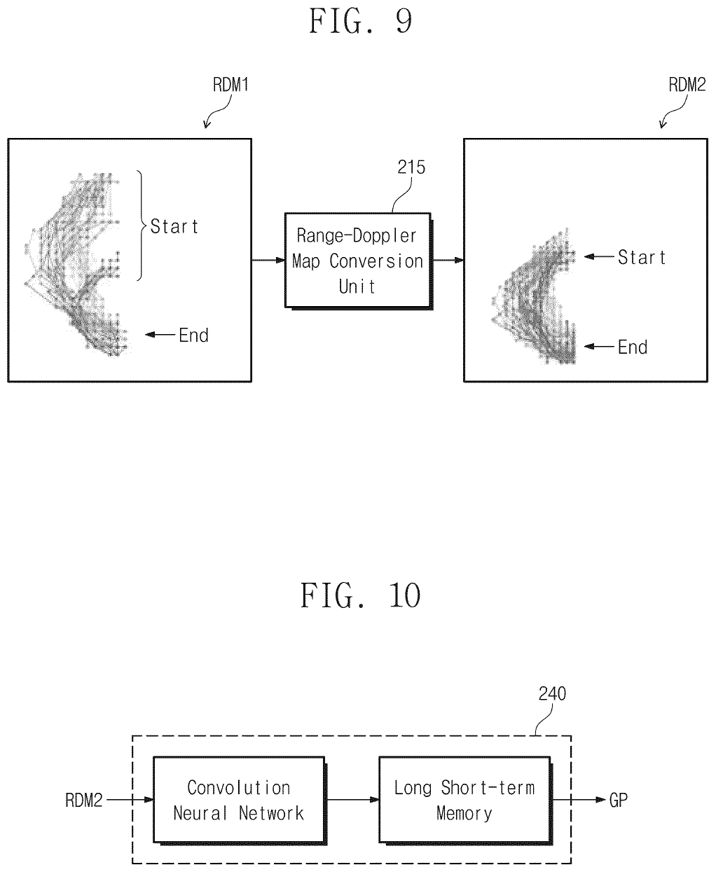

FIG. 9 is a diagram illustrating an operation of a range-Doppler map conversion unit, according to an embodiment of the present disclosure.

Referring to FIGS. 4, 8, and 9, the range-Doppler map conversion unit 215 may receive the first range-Doppler map RDM1. The range-Doppler map conversion unit 215 may perform a parallel movement of the first range-Doppler map

RDM1 based on the distance DS in accordance with the motion start MS and the motion end ME and generate the second range Doppler map RDP2.

In FIG. 9, ‘Start’ may refer to the motion start MS, and ‘End’ may refer to the motion end ME.

The first range-Doppler map RDM1 may include a peak trajectory corresponding to a gesture of the object 10. Even with the same gesture, the temporal change in the peak trajectory of the first range-Doppler map RDM1 may differ each time due to slight differences in distance and speed, as illustrated in FIG. 9. This means that even with the same gesture, there is a deviation in the peak trajectory.

The range-Doppler map conversion unit 215 may move the peak position of the range-Doppler map, which represents the motion start MS, to a certain position to make the distance, the speed, and the movement range of the peak in the second range-Doppler map RDM2 not deviate from the set range until the motion end ME.

In detail, the range-Doppler map conversion unit 215 may resample the peak of the first range-Doppler map RDM1. In the method of preserving peak trajectories, since the start and end points (time to draw a specific peak trajectory) are different from each gesture, the total amount of preserved vectors may not be uniform. Additionally, there may be a situation in which, due to the measurement variation or the specific condition, a location significantly deviating from an expected trajectory is regarded as a peak. The range-Doppler map conversion unit 215 may converge various data deviations by correcting this.

Unlike the present disclosure, even with the same gesture, deviations may occur due to the distance from the sensor 100 (refer to FIG. 1) and speed of the object 10 (refer to FIG. 1). Conventionally, it is necessary to collect and interpret various data, and significant data deviations lead to an increased computational load for the gesture sensing device 200 (refer to FIG. 1). However, according to the present disclosure, the preprocessing unit 210 may calculate the second range-Doppler map RDM2 by suppressing the deviations in the first range-Doppler map RDM1 using a plurality of first range-Doppler maps RDM1 received from each of the plurality of frames. In addition, the efficiency of gesture classification may be improved. As a result, the amount of calculation of the gesture sensing unit 240 may be reduced, and the gesture sensing device 200 (refer to FIG. 1) may be miniaturized. Accordingly, the gesture sensing device 200 (refer to FIG. 1) and the gesture sensing method with improved reliability may be provided.

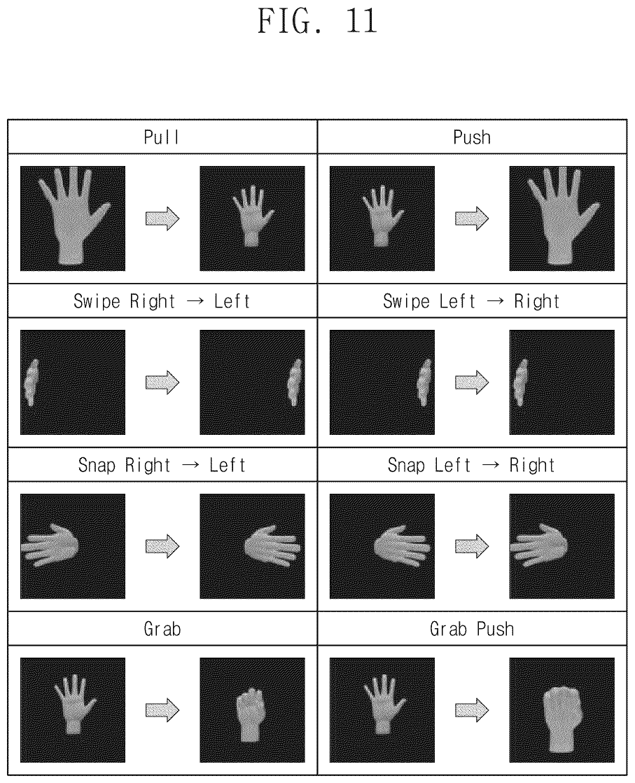

FIG. 10 is a block diagram illustrating a gesture sensing unit, according to the present disclosure, and FIG. 11 is a diagram illustrating types of gestures, according to an embodiment of the present disclosure.

Referring to FIGS. 3, 10, and 11, the gesture sensing unit 240 may receive the second range-Doppler map RDM2 and may output the gesture probability GP.

The gesture sensing unit 240 may include an artificial neural network. The gesture sensing unit 240 may include convolution neural networks (CNN) and a long short-term memory (LSTM). The long short-term memory may include recurrent neural networks (RNN). The gesture sensing unit 240 may determine the gesture of the object 10 (refer to FIG. 1) based on the second range-Doppler map RDM2, and may generate and output the gesture probability GP for each gesture.

The gesture may include operations such as a pull, a push, a swipe, a snap, a grab, and a grab push.

When the object 10 (refer to FIG. 1) is a hand, the pull gesture may be defined as a motion of approaching the sensor 100 (refer to FIG. 1) with an open hand. The push gesture may be defined as a motion of moving away from the sensor 100 (refer to FIG. 1) with the open hand. The swipe gesture may be defined as a motion of moving the hand left and right above the sensor 100 (refer to FIG. 1). The swipe gesture may include a gesture swiping from right to left or from left to right. The snap gesture may be defined as a motion of pointing the hand toward the sensor 100 (refer to FIG. 1) and moving the wrist left and right. The snap gesture may include a gesture snapping from right to left or from left to right. The grab gesture may be defined as a motion of clenching the hand from an open position. The grab push gesture may be defined as a motion of clenching the hand and approaching the sensor 100 (refer to FIG. 1).

Table 1 illustrates the number of outputs of the artificial neural network in the gesture sensing device according to comparative examples and an embodiment of the present disclosure, along with the corresponding gesture recognition rate. The comparative examples include the convolution neural network and the long short-term memory, but do not include the preprocessing unit 210. The artificial neural network may be composed of a plurality of nodes. Each of the plurality of nodes may be one calculation unit composed of a plurality of functions. In this case, the calculation unit may mimic a neural network. A unit in which the plurality of nodes is separated by purpose may be referred to as a layer.

TABLE 1

| | Comparative | Comparative | Embodiment of |
|---|---|---|---|
| | example1 | example 2 | present disclosure |
| Number of CNN | 5 | 6 | 5 |
| layers | | | |
| Number of CNN | 1936 | 512 | 16 |
| outputs | | | |
| Number of LSTM | 1 | 1 | 1 |
| layers | | | |
| Number of LSTM | 128 | 512 | 32 |
| outputs | | | |
| Total number of | 1.1M | 2.5M | 0.03M |
| parameters | | | |
| Number of gestures | 5 | 11 | 8 |
| Gesture recognition | 94% | 87% | 92% |
| rate | | | |

In comparative examples and an embodiment of the present disclosure, the number of layers of the convolution neural network and the number of layers of the short long-term memory may be substantially equal to each other.

However, the comparative examples do not include the preprocessing

unit 210, and thus may receive the first range-Doppler map RDM1 converted from the radar data RXS.

According to comparative examples, even with the same gesture, a deviation in the distance from the sensor 100 (refer to FIG. 1) and in the speed of the object 10 (refer to FIG. 1) may occur. When the first range-Doppler map RDM1 is used, it requires the collection and interpretation of various data, which may lead to increased data deviation. For this reason, the number of calculations processed by the convolution neural network and the long short-term memory may increase.

For example, in the comparative example 1, the number of outputs of the convolution neural network may be 1936, and the number of outputs of the long short-term memory may be 128. Accordingly, the total number of parameters in the comparative example 1 may be 1.1M (million). In the comparative example 1, the number of gestures output as the gesture probability may be 5. The gesture recognition rate determined through the comparative example 1 may be 94%.

In the comparative example 2, the number of outputs of the convolution neural network may be 512, and the number of outputs of the long short-term memory may be 512. As a result, the total number of parameters in the comparative example 2 may be 2.5M. In the comparative example 2, the number of gestures output as the gesture probability may be 11. The recognition rate of the gesture determined through the comparative example 2 may be 87%.

In contrast, the gesture sensing unit 240 according to an embodiment of the present disclosure may receive the processed second range-Doppler map RDM2 from the preprocessing unit 210. The second range-Doppler map RDM2 may be calculated by suppressing the deviations in the first range-Doppler map RDM1. For example, in an embodiment, the number of outputs of the convolution neural network may be 16, and the number of outputs of the long short-term memory may be 32. As a result, the total number of parameters in the embodiment may be 0.03M. In the embodiment, the number of gestures output as the gesture probability GP may be 8,and the recognition rate of the gesture determined through this may be 92%.

Unlike the present disclosure, the gesture sensing device of comparative examples may utilize large artificial neural networks to achieve high recognition precision. For this reason, it may not be suitable for mounting on small or medium-sized electronic devices. However, according to the present disclosure, the gesture sensing device 200 may include the preprocessing unit 210. The preprocessing unit 210 may suppress the deviations in the first range-Doppler map RDM1 using the plurality of the first range-Doppler maps RDM1 received from each of the plurality of frames to calculate the second range-Doppler map RDM2. In addition, the efficiency of gesture classification may be improved. As a result, the computational load of the gesture sensing unit 240 may be reduced, and the gesture sensing device 200 may be miniaturized. Accordingly, the gesture sensing device 200 and the gesture sensing method with improved reliability may be provided.

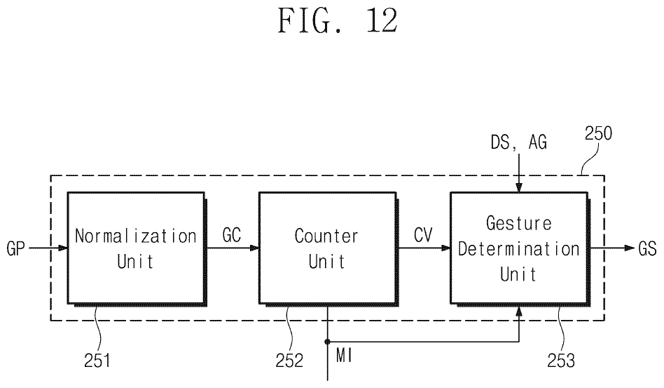

FIG. 12 is a block diagram illustrating a postprocessing unit, according to an embodiment of the present disclosure.

Referring to FIG. 12, the postprocessing unit 250 may receive the motion information MI, the distance DS, the angle AG, and the gesture probability GP, and may output the gesture signal GS including the gesture of the object 10 (refer to FIG. 1). In detail, the postprocessing unit 250 may receive the gesture probability GP and may output the final gesture classification result.

The postprocessing unit 250 may include a normalization unit 251, a counter unit 252, and a gesture determination unit 253.

The normalization unit 251 may normalize the gesture probability GP to generate a normalized gesture probability GP″. The normalization unit 251 may output a gesture candidate GC by classifying the gesture probability GP having a value greater than a predetermined value during a period between the motion start and the motion end.

When the gesture candidate GC is input during the period between the motion start and the motion end, the counter unit 252 may count the gesture probability GP with respect to the gesture candidate GC to output a count value CV.

After the motion ends, the gesture determination unit 253 may determine the gesture based on the distance DS and the angle AG, starting with the gesture probability GP having the highest count value CV, and may output the gesture signal GS.

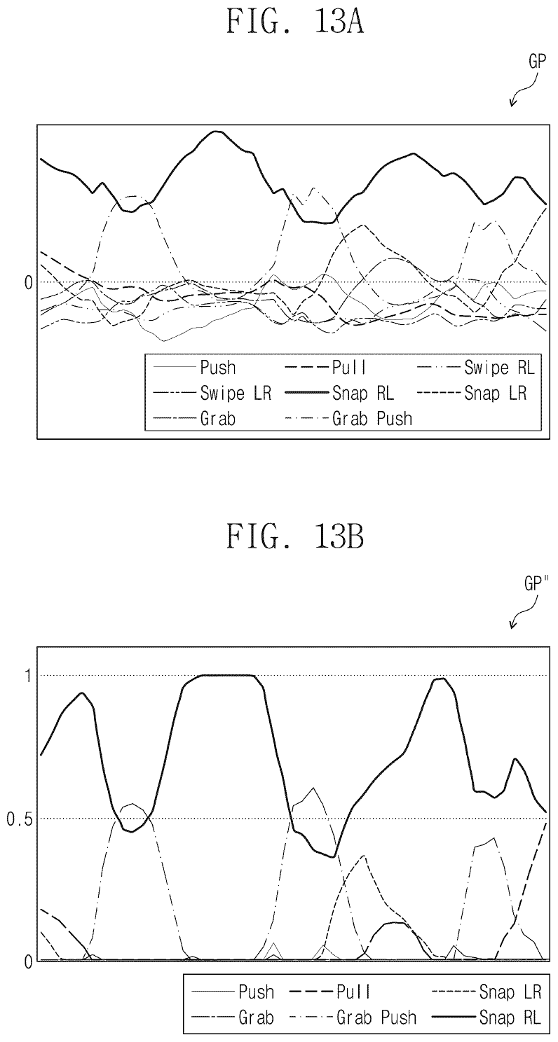

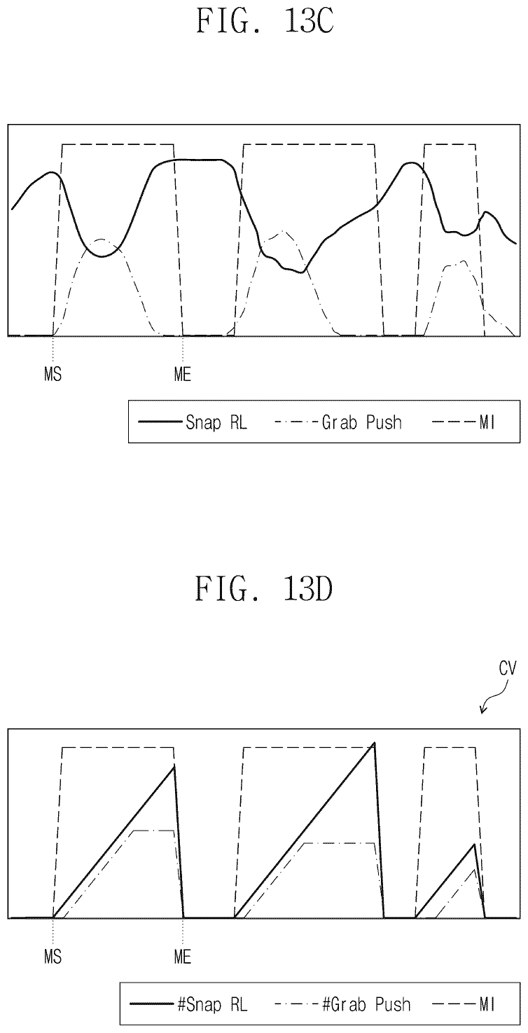

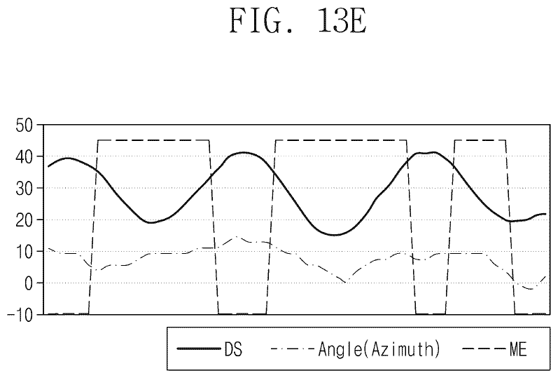

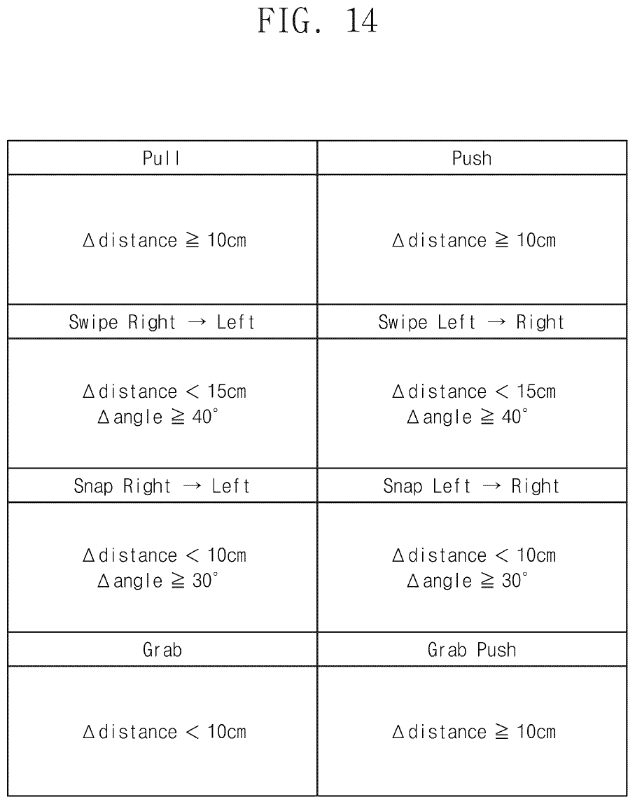

FIG. 13A is a graph illustrating a gesture probability, according to an embodiment of the present disclosure, FIG. 13B is a graph illustrating a normalized gesture probability, according to an embodiment of the present disclosure, and FIG. 13C is a graph illustrating gesture candidates, according to an embodiment of the present disclosure.

Referring to FIGS. 12, 13A, 13B, and 13C, the gesture probability GP may represent the probability with respect to each of a Pull, a Push, a Swipe RL (right and left), a Swipe LR, a Snap RL, a Snap LR, a Grab, and a Grab push over time.

FIG. 13A illustrates the gesture probability GP sensed by the gesture sensing device 200 (refer to FIG. 1) when the object 10 (refer to FIG. 1) performs the grab push operation three times.

Among the gesture probability GP, the normalization unit 251 may set the probability having a value less than ‘0’ among the gesture probability GP to ‘0’. This may be expressed as Equation 6 below. The normalization unit 251 may convert the gesture probability GP into a conversion gesture probability GP' based on Equation 6 below.

$${GP}^{′} = \{ \begin{matrix}GP & GP \geq 0 \\ 0 & GP < 0\end{matrix} \qquad [ Equation 6 ]$$

Thereafter, the normalization unit 251 may normalize the gesture probability to have the total sum equal to ‘1’. This may be expressed as Equation 7 below. The normalization unit 251 may convert the conversion gesture probability GP′ into the normalized gesture probability GP″ based on Equation 7 below.

$${GP}^{″} = {GP}^{′} / \sum {GP}^{′} \qquad [ Equation 7 ]$$

Gestures having a probability less than ‘0’ may be excluded. Through this step, the swipe RL and the swipe LR may be excluded, as depicted in FIG. 13B.

The normalization unit 251 may extract at least one gesture candidate GC based on the conversion gesture probability GP′ and the normalized gesture probability GP″. For example, the normalization unit 251 may classify the gesture probabilities GP having the conversion gesture probability GP' more than 2 and the normalized gesture probability GP″ more than 0.3 and may output the classified result as the gesture candidate GC.

In FIG. 13C, the Snap RL and the Grab push are illustrated as gestures that satisfy the above conditions and are output as the gesture candidate GC.

The motion information MI may include information about a motion start MS and a motion end ME.

FIG. 13D is a graph illustrating count values and motion information, according to an embodiment of the present disclosure.

Referring to FIGS. 12 and 13D, the counter unit 252 may receive the gesture candidate GC from the normalization unit 251 and may receive the motion information MI from the motion sensing unit 230 (refer to FIG. 3).

The counter unit 252 may reset the counter value CV to ‘0’ at the time of the motion start MS and the motion end ME. When the gesture candidate GC is input during a period between the motion start MS and the motion end ME, the counter unit 252 may add ‘1’ to the counter value CV of the corresponding gesture.

At the time of the motion end ME, the counter value CV (#Snap RL) of the Snap RL may be greater than the counter value CV (#Grab push) of the grab push.

FIG. 13E is a graph illustrating a distance, an angle, and motion information, according to an embodiment of the present disclosure, and FIG. 14 is a diagram illustrating gestures depending on a distance and an angle, according to an embodiment of the present disclosure.

Referring to FIGS. 12, 13E, and 14, the gesture determination unit 253 may receive the distance DS and the angle AG from the preprocessing unit 210 (refer to FIG. 3). The gesture determination unit 253 may receive the motion information MI from the motion sensing unit 230 (refer to FIG. 3). The gesture determination unit 253 may operate at the time of the motion end ME.

The gesture determination unit 253 may calculate the amount of change in distance DS between the current distance DS and the past distance DS, and may calculate the amount of change in angle AG between the current angle AG and the past angle AG. The amount of change in the distance DS may be defined as Δdistance, and the amount of change in the angle AG may be defined as Δangle.

The gesture determination unit 253 may sequentially determine whether the gestures having the highest counter value CV meet the criteria for the distance DS and the angle AG, and output the final gesture classification result at time of the motion end ME.

When the amount of change in the distance DS is more than 10 centimeters, the gesture determination unit 253 may determine the gesture to be the pull operation, the push operation, or the grab push motion.

When the amount of change in the distance DS is less than 15 cm and the amount of change in the angle AG is more than 40 degrees, the gesture determination unit 253 may determine the gesture to be the swipe motion.

When the amount of change in the distance DS is less than 10 cm and the amount of change in the angle AG is more than 30 degrees, the gesture determination unit 253 may determine the gesture to be the snap motion.

When the amount of change in distance DS is less than 10 cm, the gesture determination unit 253 may determine the gesture to be the grab motion.

In the embodiment of FIGS. 13A to 13E, the gesture determination unit 253 may first determine a gesture with respect to the Snap RL with the highest counter value CV at the time of the motion end ME. For example, when the amount of change in the distance DS between the motion start MS and the motion end ME according to an embodiment is 20 cm, and the amount of change in the angle AG according to an embodiment is 10 degrees, the gesture determination unit 253 may determine that the gesture is not the Snap RL.

Afterwards, the gesture determination unit 253 may determine the gesture with respect to a grab with the next highest counter value CV. For example, since the amount of change in the distance DS between the motion start MS and the motion end ME is 20 cm, and the amount of change in angle AG is 10 degrees, the gesture determination unit 253 may determine the gesture to be the grab push.

A classification result of gestures may be obtained at the time of the motion end ME through the gesture sensing method of the gesture sensing device 200 (refer to FIG. 1) according to an embodiment of the present disclosure. The gesture sensing device 200 (refer to FIG. 1) may prevent incorrect output from occurring during periods without motion or during a motion by using the motion information MI.

According to the present disclosure, the gesture sensing device 200 (refer to FIG. 1) may include the preprocessing unit 210 (refer to FIG. 3). The preprocessing unit 210 (refer to FIG. 3) may calculate the second range-Doppler map RDM2 leading to the improved gesture classification efficiency. The postprocessing unit 250 (refer to FIG. 3) may easily determine the gesture based on the second range-Doppler map RDM2. Accordingly, the gesture sensing device 200 and the gesture sensing method according to the present disclosure may provide the improved reliability.

According to an embodiment of the present disclosure, the gesture sensing device may include the preprocessing unit, the gesture sensing unit, and the postprocessing unit. The preprocessing unit may calculate the second range-Doppler map by suppressing the deviations in the first range-Doppler map using the plurality of the first range-Doppler maps received from each of the plurality of frames. In addition, the efficiency of gesture classification may be improved. As a result, the amount of calculation in the gesture sensing unit may be reduced, and miniaturization of the gesture sensing device may be achieved. The postprocessing unit may easily determine the gesture based on the second range-Doppler map. Accordingly, it is possible to provide the gesture sensing device and the gesture sensing method having improved reliability.

Although an embodiment of the present disclosure has been described for illustrative purposes, those skilled in the art will appreciate that various modifications are possible, without departing from the scope and spirit of the present disclosure as set forth in the following claims. Accordingly, it is understood that the technical scope of the present disclosure is not limited to the detailed description above, but should be defined by the claims.

What is claimed is:

1. A gesture sensing device comprising:
a preprocessing unit receiving radar data from a sensor, and generating a first range-Doppler map including a distance to an object and information about a relative speed based on the radar data and a second range-Doppler map;
a motion sensing unit receiving the first range-Doppler map and generating a motion information including a motion start and a motion end based on a signal strength calculated based on the first range-Doppler map; and
a gesture sensing unit receiving the second range-Doppler map and the motion information, and generating a gesture probability by classifying gesture features of the object based on the second range-Doppler map,
wherein the second range-Doppler map is generated in the preprocessing unit using the first range-Doppler map and the motion information.

2. The gesture sensing device of claim 1, further comprises a memory unit configured to store the first range-Doppler map of each of a plurality of frames,
wherein the motion sensing unit calculates a plurality of differential signal strengths, each of which is calculated using signal strengths of two adjacent frames, and calculates an average value of the plurality of differential signal strengths.

3. The gesture sensing device of claim 2, wherein the motion sensing unit determines the motion start based on the average value and a slope value obtained by differentiating the average value.

4. The gesture sensing device of claim 2, wherein the motion sensing unit calculates a normal signal strength by normalizing the average value during a period between a time of the motion start and a present time, and determines the motion end based on a magnitude of the normal signal strength.

5. The gesture sensing device of claim 1, wherein the preprocessing unit includes:
a range-Doppler map generating unit configured to generate the first range-Doppler map;
a peak sensing unit configured to sense the distance based on a peak of the signal strength;
a beamforming unit configured to calculate an angle to the object based on the first range-Doppler map; and
a range-Doppler map conversion unit configured to generate the second range-Doppler map.

6. The gesture sensing device of claim 5, wherein the preprocessing unit further includes a filter unit configured to receive the radar data, and wherein the filter unit includes an infinite impulse response filter.

7. The gesture sensing device of claim 5, wherein the range-Doppler map conversion unit generates the second range-Doppler map by performing a parallel movement of the first range-Doppler map based on the distance in accordance with the motion start and the motion end.

8. The gesture sensing device of claim 5, wherein the preprocessing unit further includes a motion log unit, and
wherein the motion log unit receives the motion information, the distance and the angle, and records and outputs the distance and the angle during a period between the motion start and the motion end.

9. The gesture sensing device of claim 1, wherein the gesture sensing unit includes a convolution neural network (CNN) and a long short-term memory (LSTM).

10. The gesture sensing device of claim 5, further comprises a postprocessing unit configured to receive the motion information, the distance, the angle and the gesture probability, and to output a gesture of the object.

11. The gesture sensing device of claim 10, wherein the postprocessing unit includes:
a normalization unit configured to normalize the gesture probability and to classify the gesture probability above a predetermined value during a period between the motion start and the motion end;
a counter unit configured to count the gesture probability during the period between the motion start and the motion end to output a count value; and
a gesture determination unit configured to output the gesture based on the distance and the angle, starting with the gesture probability having a highest count value after the motion end.

12. The gesture sensing device of claim 1, wherein the radar data is a signal received in a millimeter wave.

13. The gesture sensing device of claim 1, wherein the preprocessing unit performs a fast Fourier transform on the radar data to generate the first range-Doppler map.

14. A gesture sensing method comprising:
generating a first range-Doppler map including a distance to an object and information about a relative speed based on radar data;
generating motion information including a motion start and a motion end based on a signal strength calculated based on the first range-Doppler map;
generating a second range-Doppler map different from the first range-Doppler map based on the first range-Doppler map and the motion information; and
generating a gesture probability by classifying gesture features of the object based on the second range-Doppler map.

15. The gesture sensing method of claim 14, wherein the generating the motion information includes:
calculating a plurality of differential signal strengths, each of the plurality of differential signal strengths being calculated using signal strengths of two adjacent frames;
calculating an average value of the plurality of differential signal strengths;
determining the motion start based on the average value and a slope value obtained by differentiating the average value;
calculating a normal signal strength by normalizing the average value during a period between a time of the motion start and a present time; and
determining the motion end based on a magnitude of the normal signal strength.

16. The gesture sensing method of claim 14, wherein the generating the second range-Doppler map includes performing a parallel movement of the first range-Doppler map based on the distance in accordance with the motion start and the motion end.

17. The gesture sensing method of claim 14, wherein the generating the gesture probability includes outputting the gesture probability from the second range-Doppler map using a convolution neural network (CNN) and a long short-term memory (LSTM).

18. The gesture sensing method of claim 14, further comprising:
receiving the motion information, the distance and the gesture probability; and
outputting a gesture of the object.

19. The gesture sensing method of claim 18, wherein the outputting the gesture includes:
normalizing the gesture probability and classifying the gesture probability above a predetermined value during a period between the motion start and the motion end;
counting the gesture probability during the period between the motion start and the motion end, and outputting a count value; and
outputting a gesture signal including the gesture based on the distance, starting with the gesture probability having a highest count value after the motion end.

20. The gesture sensing method of claim 14. wherein the radar data is a signal received in a millimeter wave.
